(19) United States
(12) Patent Application Publication
(10) Pub. No.: US 2020/0104839 A1
(43) Pub. Date: Apr. 2, 2020

(54) SECURE PAYMENT TRANSACTION SYSTEMS AND METHODS

(71) Applicant: NOWACCOUNT NETWORK CORPORATION, Atlanta, GA (US)

(72) Inventors: John Benjamin Hayes, Atlanta, GA (US); Claudio Alexander Avendano, Atlanta, GA (US); Laura O'Connor Hodgson, Atlanta, GA (US)

(21) Appl. No.: 16/585,926

(22) Filed: Sep. 27, 2019

Related U.S. Application Data
(60) Provisional application No. 62/738,679, filed on Sep. 28, 2018.

(51) Int. Cl. G06Q 20/38; G06Q 20/40; G06F 16/953

(52) U.S. Cl. CPC G06Q 20/3829; G06F 16/953; G06Q 20/401

(57) ABSTRACT

Disclosed are a secure payment system and methods that may involve facilitating secured transactions between a payee and payor, or any other types of users. Such systems and methods may involve creating a secure information vault, determine that a first user has completed a registration process for access to the secure information vault, determining that the first user is a verified user, facilitating, based on the determination that the first user has completed the registration process and the determination that the first user is a verified user, access of the first user to the secure information vault, storing data in the secure information vault, wherein the data includes at least one of an address for physical delivery of payments and an address for electronic delivery of payments, and wherein the data is associated with the first user, linking the first user to users a second user by facilitating secure communications and requesting link confirmations between the first user and second user, and facilitating a payment between the first user and second user based on the data stored in the vault associated with the first user.

### TECHNICAL FIELD

The disclosure generally relates to payment systems, and, in particular, relates to secure payment transaction systems and methods.

### BACKGROUND

Businesses and their supply chains are under attack from cyber-criminals that use a variety of cybercrimes to cause remittance payments to be diverted to fraudulent bank accounts. Business email is a primary source of compromise; even additional email security steps, such as multi-factor authentication, are not effective in stopping remittance fraud.

When remittance fraud occurs, there are generally three costs: (1) the payment itself may be fraudulently diverted to a cyber-criminal and not paid to the proper payee; (2) the cost to a payment intermediary or processor of resolving the liability when the payment has been fraudulently diverted; and (3) the relationship between the payor (buyer) and payee (seller) may be damaged due to the friction of resolving the fraudulent payment issue.

### SUMMARY

Systems and methods for secure payment transactions are disclosed.

In various embodiments, a computer-implemented method is provided. The computer-implemented method may include creating, by a payment system, a secure information vault. In various embodiments, the method may also include determining, by the payment system, that a user has completed a registration process for access to the secure information vault. In various embodiments, the method may also include determining, by the payment system, that the user is a verified user. In various embodiments, the method may also include facilitating, by the payment system, and based on the determination that the user has completed the registration process and the determination that the user is a verified user, access of the user to the secure information vault. In various embodiments, the method may also include storing, by the payment system, data in the secure information vault, wherein the data includes at least one of an address for physical delivery of payments and an address for the electronic delivery of payments, and wherein the data is associated with the user. In various embodiments, the method may also include linking, by the payment system, the user to a second user registered with the secure information vault by facilitating secure communications and requesting link confirmations between the first user and second user. In various embodiments, the method may also include facilitating, by the payment system, a payment between the first user and second user based on the data stored in the vault associated with the user

In various embodiments, the first user is a payee and the second user is a payor.

In various embodiments, the first user comprises at least one of an individual or an entity.

In various embodiments, determining that the first user is a verified user further comprises at least one of: searching for the first user in a global cybercrime database; searching company records for entity and Federal Employee Identification Numbers (FEIN) associated with the first user; searching a database using a name, home address, home phone number, or state driver's license number of the first user, searching for entity registration, annual filings, registered officers, and a registered agent associated with the first user; performing an internet search engine search for an individual name, entity name, or IP address used to login or register with the vault module, any email addresses, domain names, phone numbers, or physical mailing addresses provided during the registration process; searching a map application program or website for the physical mailing address to confirm a mapped building matches a disclosed description; searching a professional social media website for an individual names or entity name associated with the first user; searching a website of the first user to confirm a match with any disclosed information; using multi-factor authentication with the first user through at least two different methods from among phone text, phone call, and alternative email; and requiring at least two users from an entity be confirmed and credentialed.

In various embodiments, linking the first user to a second user further includes receiving, from the first user, a request to establish a link with a second user, and determining that the second user is registered with the secure information vault;

In various embodiments, linking the first user to a second user further include receiving, from the first user, a request to establish a link with a second user, determining that the second user is not registered with the secure information vault, sending an invitation to the second user to register with the secure information vault, and determining, subsequent to sending the invitation, that the second user has registered with the secure information vault.

In various embodiments, the method may also include receiving, from the first user, an indication of one or more payments to be assigned to at a third user, wherein the third user is an assignee, generating a notification, on behalf of the third user, that the second user is to only pay the third user, and facilitating payment to the first user based on the data stored in the secure information vault, wherein the payment discharges a payment obligation of the second user.

In various embodiments, the method may also include creating a first cryptographic hash key that is unique to the processor and the data, creating, periodically, a second cryptographic hash key unique to the processor and the data, comparing the first cryptographic hash key and the second cryptographic hash key, determining, based on the comparison of the first cryptographic hash key and the second cryptographic hash key, that the first cryptographic hash key and the second cryptographic hash key are different, and determining, based on the determination that the first cryptographic hash key and the second cryptographic hash key are different, that the data was altered without authorization.

In various embodiments, the method may also include creating a first cryptographic hash key that is unique to the processor and the data, determining that the data has been accessed by the first user or the second user, creating, based on the determination that the data has been accessed by the first user or the second user, a second cryptographic hash key unique to the processor and the data, comparing the first cryptographic hash key and the second cryptographic hash key, determining, based on the comparison of the first cryptographic hash key and the second cryptographic hash key, that the first cryptographic hash key and the second cryptographic hash key are different, and determining, based on the determination that the first cryptographic hash key and the second cryptographic hash key are different, that the data was altered without authorization.

In various embodiments, the method may also include creating a first cryptographic hash key that is unique to the processor and the data, determining that the data has been modified by an authorized user, and creating a second cryptographic hash key unique to the processor and the modified data

In various embodiments, a secure payment system is provided. The system may include a computer processor operable to execute a set of computer-readable instructions, and a memory operable to store the set of computer-readable instructions. In various embodiments, the computer-executable instructions may cause the system to create a secure information vault. In various embodiments, the computer-executable instructions may cause the system to determine that a first user has completed a registration process for access to the secure information vault. In various embodiments, the computer-executable instructions may cause the system to determine that the first user is a verified user. In various embodiments, the computer-executable instructions may cause the system to facilitate, based on the determination that the first user has completed the registration process and the determination that the first user is a verified user, access of the first user to the secure information vault. In various embodiments, the computer-executable instructions may cause the system to store data in the secure information vault, wherein the data includes at least one of an address for physical delivery of payments and an address for the electronic delivery of payments, and wherein the data is associated with the first user. In various embodiments, the computer-executable instructions may cause the system to link the first user to a second user by facilitating secure communications and requesting link confirmations between the first user and second user. In various embodiments, the computer-executable instructions may cause the system to facilitate a payment between the first user and second user based on the data stored in the vault associated with the first user.

In various embodiments, the first user is a payee and the second user is a payor.

In various embodiments, the first user comprises at least one of an individual or an entity.

In various embodiments, determining that the first user is a verified user further comprises at least one of: searching for the first user in a global cybercrime database; searching company records for entity and Federal Employee Identification Numbers (FEIN) associated with the first user; searching a database using a name, home address, home phone number, or state driver's license number of the first user, searching for entity registration, annual filings, registered officers, and a registered agent associated with the first user; performing an internet search engine search for an individual name, entity name, or IP address used to login or register with the vault module, any email addresses, domain names, phone numbers, or physical mailing addresses provided during the registration process; searching a map application program or website for the physical mailing address to confirm a mapped building matches a disclosed description; searching a professional social media website for an individual names or entity name associated with the first user; searching a website of the first user to confirm a match with any disclosed information; using multi-factor authentication with the first user through at least two different methods from among phone text, phone call, and alternative email; and requiring at least two users from an entity be confirmed and credentialed.

In various embodiments, linking the first user to a second user further includes receiving, from the first user, a request to establish a link with a second user, and determining that the second user is registered with the secure information vault;

In various embodiments, linking the first user to a second user further include receiving, from the first user, a request to establish a link with a second user, determining that the second user is not registered with the secure information vault, sending an invitation to the second user to register with the secure information vault, and determining, subsequent to sending the invitation, that the second user has registered with the secure information vault.

In various embodiments, the computer-executable instructions may are further operable to receive, from the first user, an indication of one or more payments to be assigned to at a third user, wherein the third user is an assignee, generating a notification, on behalf of the third user, that the second user is to only pay the third user, and facilitating payment to the first user based on the data stored in the secure information vault, wherein the payment discharges a payment obligation of the second user.

In various embodiments, the computer-executable instructions may are further operable to create a first cryptographic hash key that is unique to the processor and the data, create, periodically, a second cryptographic hash key unique to the processor and the data, compare the first cryptographic hash key and the second cryptographic hash key, determine, based on the comparison of the first cryptographic hash key and the second cryptographic hash key, that the first cryptographic hash key and the second cryptographic hash key are different, and determine, based on the determination that the first cryptographic hash key and the second cryptographic hash key are different, that the data was altered without authorization.

In various embodiments, the computer-executable instructions may are further operable to create a first cryptographic hash key that is unique to the processor and the data, determine that the data has been accessed by the first user or the second user, create, based on the determination that the data has been accessed by the first user or the second user, a second cryptographic hash key unique to the processor and the data, compare the first cryptographic hash key and the second cryptographic hash key, determine, based on the comparison of the first cryptographic hash key and the second cryptographic hash key, that the first cryptographic hash key and the second cryptographic hash key are different, and determine, based on the determination that the first cryptographic hash key and the second cryptographic hash key are different, that the data was altered without authorization.

In various embodiments, the computer-executable instructions may are further operable to create a first cryptographic hash key that is unique to the processor and the data, determine that the data has been modified by an authorized user, and create a second cryptographic hash key unique to the processor and the modified data

Additional systems, methods, apparatus, features, and aspects are realized through the techniques of various embodiments of the disclosure. Other embodiments and aspects of the disclosure are described in detail herein and are considered a part of the claimed subject matter. Other features can be understood and will become apparent with reference to the description and to the drawings.

### BRIEF DESCRIPTION OF THE DRAWINGS

FIG. 1 illustrates an example system architecture according to an embodiment of the disclosure.

FIG. 2 illustrates an example process flowchart for a method according to an embodiment of the disclosure.

FIG. 3 illustrates an example process flowchart for another method according to an embodiment of the disclosure.

FIG. 4 illustrates an example computer system according to an embodiment of the disclosure.

FIG. 5 illustrates an example computer processor according to an embodiment of the disclosure.

### DETAILED DESCRIPTION OF THE DISCLOSURE

Embodiments of the disclosure can provide secure payment transaction systems and methods. Certain embodiments of the disclosure can provide systems and methods to facilitate protecting remittance addresses, including mail delivery and bank payment addresses, and prevent remittance payments sent to protected remittance addresses from being fraudulently diverted. Certain embodiments of the disclosure can provide technical solutions to significantly reduce remittance fraud. Certain embodiments of the disclosure can provide technical solutions to protect the integrity of a supply chain payment process. Further, certain embodiments of the disclosure can provide technical solutions to secure certain remittance information, such as mail delivery and bank payment addresses, and to prevent remittance payments from being fraudulently diverted.

In one embodiment of the disclosure, a computer-implemented method can facilitate creation of a relatively secure information “vault.” The vault can be implemented as an application program module executing on a server or other computing device accessible via a network, such as the Internet or local area network. The application program module can store data in one or more data stores, databases, and/or data files stored on the server or otherwise accessible via a network, such as the Internet or local area network. The vault can securely receive and store, for example, the addresses for physical delivery of payments (e.g., paper checks) and the electronic delivery of payments (e.g., electronic wire and ACH (Automated Clearing House)). The vault can only be accessed by persons and/or entities (collectively “users”, or individually a “user”) who have first registered to access the vault, and subsequently have been confirmed to access the vault through a verification process, which can include multiple iterations and/or operations to verify the identity of the user registered to access the vault. After successfully registering each user, and having verified each user registered to access the vault, the method can facilitate linking a user to any number of designated other users by facilitating secure communications and requesting link confirmations between the users as needed. After links between users are confirmed, users that have confirmed links between each other can fully access the vault's functionality to facilitate payments between each other using information stored in the vault, including addresses for physical delivery of payments (e.g., paper checks) and the electronic delivery of payments (e.g., electronic wire and ACH (Automated Clearing House)).

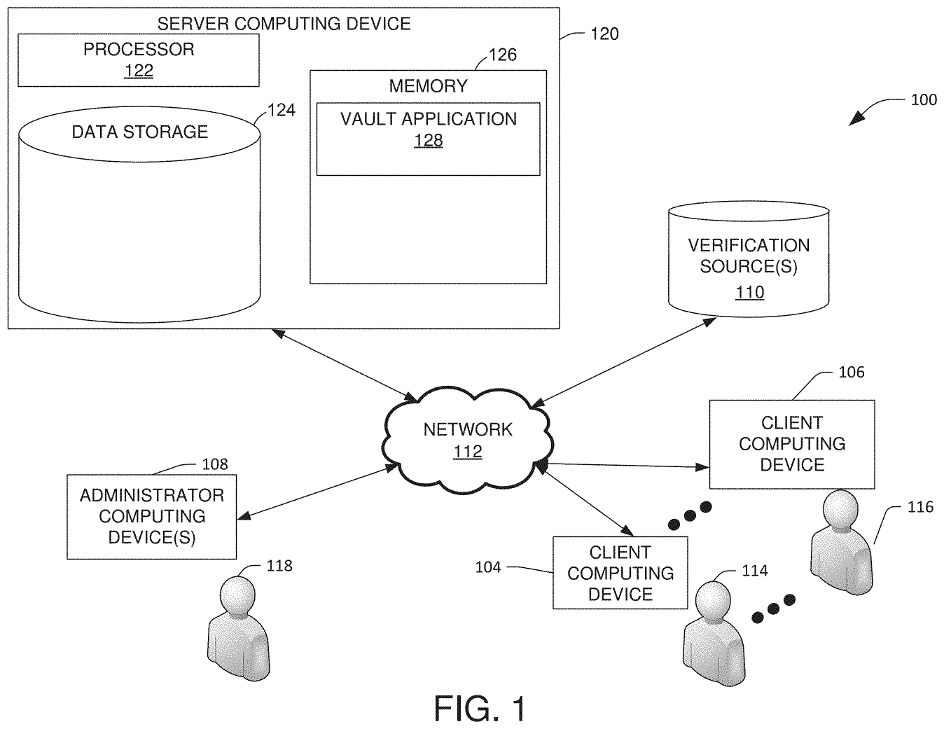

Embodiments of the disclosure can provide secure payment transaction systems and methods. In the embodiment shown in FIG. 1, an example system architecture can facilitate interactions among two or more users. Users can be any number of payees (sellers), payors (buyers), lenders, investors, and/or assignees. Payees (sellers) can be a person or entity, such as a business or government, that sells goods and/or services to another person, business, entity, and/or government. Payees can also be a person or entity that is selling real or personal property. Payors (buyers) can be a person or entity, such as an individual, business, or government, that buys the goods and/or services and/or property from a payee (seller), for which the payor (buyer) would have an obligation to pay the payee (seller) for the purchased goods and/or services and/or property. Lenders can be either a payee or a payor. Investors can be either payees or payors. Assignees can, for example, be an assignee of the payee. In any instance, each of the users can operate a respective client device, such as a computer system, computing tablet, mobile communication device, etc., wherein each client device can be in communication with one or more server devices via one or more networks, including the Internet, a wide area network, or local area network.

The one or more server devices can include at least one processor and at least one memory including a set of computer-executable instructions. The instructions can be executed by the at least one processor, and the instructions can include a vault application program module, or vault module. In some embodiments, some or all of the client devices can include a vault application program module, or vault module. In any instance, a vault module can be operable to provide any number of user interfaces to facilitate registration, confirmation, verification, and linking of any number of users. The vault module can also be operable to facilitate registration of one or more users. The vault module can be further operable to confirm and verify the identity of each user. The vault module can also be operable to facilitate linking two users together, and provide secure communications between the users to link the users together. The vault module can receive confirmation from users that links between each other are valid or otherwise confirmed. Upon confirmation of a link between two users, or after a link is established between two users, the vault module can facilitate secure payments, including supply chain payments, remittance payments, purchase of property payments, and any other type of payment suitable for handling, processing, or administering by a network, for the linked users. Each of the linked users can be provided access to certain of each other's information stored by the vault module or otherwise accessible by the vault module, wherein the information can be used to facilitate payments between the linked users.

In at least one embodiment, the vault application program module, or vault module, can be implemented in a software as a service (SAAS) environment. For example, a vault module can be executed by, for example, a server device, and any number of client devices can be in communication with the server devices via one or more networks. Respective users may operate a client device to interact with the vault module.

In another embodiment, two or more vault modules can be executed by respective server devices and any number of client devices can be in communication with the server devices via one or more networks. Respective users may operate a client device to interact with at least one vault module.

### Example System Architecture

FIG. 1 is a block diagram of an example system 100 architecture in accordance with one or more embodiments of the disclosure. The illustrative system 100 may include one or more client computing devices 104 and 106 operable by a respective user 114 and 116, one or more server computing devices 120, one or more administrator computing devices 108 operable by a user 118, and one or more verification sources 110. Although only two client computing devices and two users are depicted in FIG. 1, any number of client computing devices and/or users may be applicable.

Any of the client computing devices 104 and 106, server computing devices 120, administrator computing devices 108, and verification sources 110 may be configured to communicate with each other and any other component of the system 100 via one or more networks 112. The network 112 may include, but is not limited to, any one or a combination of different types of suitable communications networks such as, for example, cable networks, public networks (e.g., the Internet), private networks, wireless networks, cellular networks, or any other suitable private and/or public networks. Further, the network 112 may have any suitable communication range associated therewith and may include, for example, global networks (e.g., the Internet), metropolitan area networks (MANs), wide area networks (WANs), local area networks (LANs), or personal area networks (PANs). In addition, the network 112 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

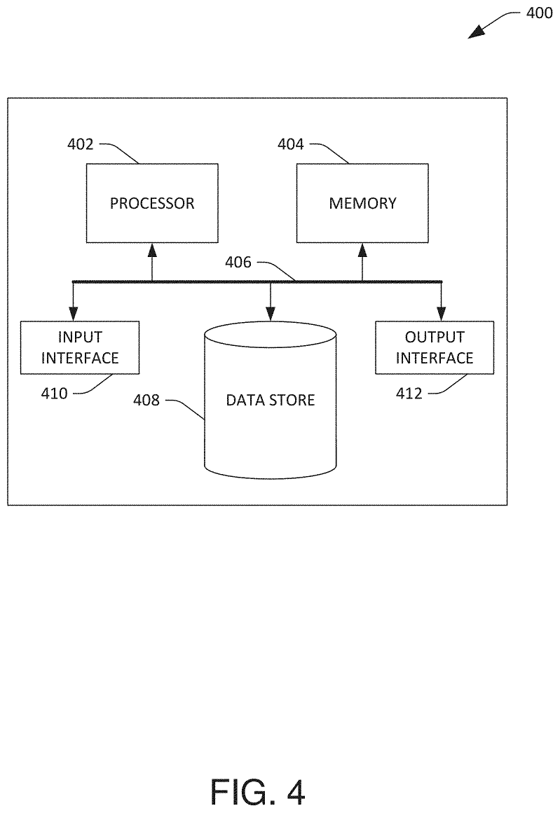

Each of the client computing devices 104 and 106, as well as the administrator computing devices 108 may include, for example, devices such as smartphones, laptop computers, or any other relevant type of device. The client computing devices 104 and 106, as well as the administrator computing devices 108 and any associated hardware may be described in more detail with respect to FIG. 4.

In some embodiments, the server computing device 120 may include one or more processors 122 that may include any suitable processing unit capable of accepting digital data as input, processing the input data based on stored computer-executable instructions, and generating output data. The computer-executable instructions may be stored, for example, in the data storage 118 and may include, among other things, operating system software and application software. The computer-executable instructions may be retrieved from the data storage 124 and loaded into the memory 126 as needed for execution. The processor 122 may be configured to execute the computer-executable instructions to cause various operations to be performed. Each processor 122 may include any type of processing unit including, but not limited to, a central processing unit, a microprocessor, a microcontroller, a Reduced Instruction Set Computer (RISC) microprocessor, a Complex Instruction Set Computer (CISC) microprocessor, an Application Specific Integrated Circuit (ASIC), a System-on-a-Chip (SoC), a field-programmable gate array (FPGA), and so forth.

The data storage 124 may store program instructions that are loadable and executable by the processors 122, as well as data manipulated and generated by one or more of the processors 122 during execution of the program instructions. The program instructions may be loaded into the memory 126 as needed for execution. Depending on the configuration and implementation of each of the client devices 104 and 106, the memory 126 may be volatile memory (memory that is not configured to retain stored information when not supplied with power) such as random access memory (RAM) and/or non-volatile memory (memory that is configured to retain stored information even when not supplied with power) such as read-only memory (ROM), flash memory, and so forth. In various implementations, the memory 126 may include multiple different types of memory, such as various forms of static random access memory (SRAM), various forms of dynamic random access memory (DRAM), unalterable ROM, and/or writeable variants of ROM such as electrically erasable programmable read-only memory (EEPROM), flash memory, and so forth.

Various program modules, applications, or the like may be stored in data storage 124 that may comprise computer-executable instructions that when executed by one or more of the processors 122 cause various operations to be performed. The memory 126 may have loaded from the data storage 124 one or more operating systems (O/S) that may provide an interface between other application software (e.g., dedicated applications, a browser application, a web-based application, a distributed client-server application, etc.) executing on the server computing device 120 and the hardware resources of the server computing device 120. More specifically, the O/S may include a set of computer-executable instructions for managing the hardware resources of the server computing device 120 and for providing common services to other application programs (e.g., managing memory allocation among various application programs). The O/S may include any operating system now known or which may be developed in the future including, but not limited to, any mobile operating system, desktop or laptop operating system, mainframe operating system, or any other proprietary or open-source operating system.

The data storage 124 may additionally include various other program modules that may include computer-executable instructions for supporting a variety of associated functionality. For example, the data storage 124 may include one or more applications, including one or more vault applications 128, or apps. In the embodiment shown, the vault application 128 can include computer-executable instructions that in response to execution by one or more processors 122 cause operations to be performed including creating, by a payment system, a secure information vault. The operations may also include determining, by the payment system, that a user has completed a registration process for access to the secure information vault. The operations may also include determining, by the payment system, that the user is a verified user. The operations may also include facilitating, by the payment system, and based on the determination that the user has completed the registration process and the determination that the user is a verified user, access of the user to the secure information vault. The operations may also include storing, by the payment system, data in the secure information vault, wherein the data includes at least one of an address for physical delivery of payments and an address for the electronic delivery of payments, and wherein the data is associated with the user. The operations may also include linking, by the payment system, the user to a second user registered with the secure information vault by facilitating secure communications and requesting link confirmations between the first user and second user. The operations may also include facilitating, by the payment system, a payment between the first user and second user based on the data stored in the vault associated with the user.

The one or more verification sources 110 may be any internal or external source used to verify a user, during registration with the secure information vault, for example. Such verification sources may be described below with respect to the verification processes, and may include, for example, a global cybercrime database or other type of database, a third party that offers information on commercial credit as well as reports on entities, a website, information provided by the user during registration, an internet search engine, a map application, a social media platform, or a multi-factor authentication system. Additionally, the website may be, for example, the Secretary of State website, which may be used to determine particular individual and entity names, for entity registration, annual filings, registered officers, and/or registered agent information. The information provided by the user during registration may include information such as a name, IP address, physical or email address, phone number, etc.

Those of skill in the art will appreciate that any of the components of the system 100 and associated architecture may include alternate and/or additional hardware, software, or firmware components beyond those described or depicted without departing from the scope of the disclosure. More particularly, it should be appreciated that hardware, software, or firmware components depicted or described as forming part of any of the illustrative components of the system 100, and the associated functionality that such components support, are merely illustrative and that some components may not be present or additional components may be provided in various embodiments. While various program modules have been depicted and described with respect to various illustrative components of the system 100, it should be appreciated that the functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of hardware, software, and/or firmware for implementing the functionality. Accordingly, it should be appreciated that the functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Further, while certain modules may be depicted and described as sub-modules of another module, in certain embodiments, such modules may be provided as independent modules.

Those of skill in the art will appreciate that the illustrative system 100 is provided by way of example only. Numerous other operating environments, system architectures, and device configurations are within the scope of this disclosure. Other embodiments of the disclosure may include fewer or greater numbers of components and/or devices and may incorporate some or all of the functionality described with respect to the illustrative system 100, or additional functionality.

### Example Registration and Verification Processes

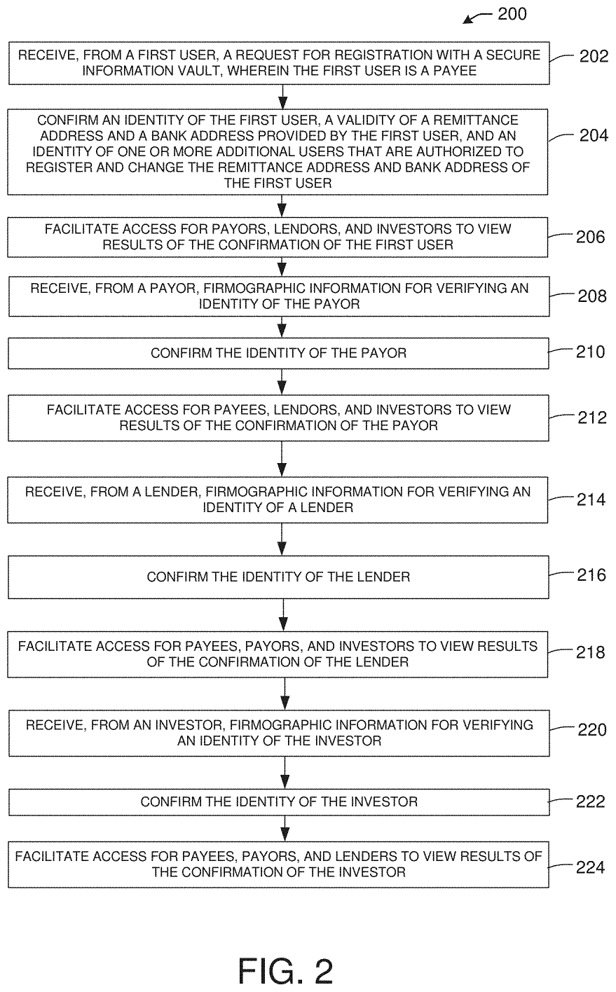

FIG. 2 illustrates a flow diagram of an example process 200 in accordance with one or more embodiments of the disclosure.

In some embodiments, the process may include an operation 202 of receiving, from a first user, a request for registration with a secure information vault, wherein the first user is a payee. The vault module may implement at least one registration and verification process to initially register and subsequently verify one or more users desiring or otherwise requesting access to a vault or vault module. In the flow diagram shown in FIG. 2, an example registration and verification process may include the following operations, though other embodiments of the disclosure may have a fewer number of, a greater number of, or different operations.

In this example embodiment, a user, such as a payee, can use a client device (for example, client computing device 104 with respect to FIG. 1) to interact with a vault module. The vault module may provide or otherwise associated user interface for a user to input to the vault module certain payment information and information used to verify the identity of the user. For example, the payee may input to the vault module both a physical remittance address and a bank address, including a routing number and account number, for electronic (wires and ACH) payments, and firmographic information that is used to initially verify the identity of the user and confirm the identity in the future. The vault module can utilize a verification process, such as described below, to confirm the identity of the payee, the physical remittance address and the bank address, and any designated individuals authorized to register and change the remittance addresses.

In some embodiments, the process may include an operation 204 of confirming an identity of the first user, a validity of a remittance address and a bank address provided by the first user, and an identity of one or more additional users that are authorized to register and change the remittance address and bank address of the first user. Confirming the identity of the first user may differ based on whether the first user is an individual or an entity. In some cases, however, the verification of the first user may also involve some of the same operations regardless of whether the first user is an individual or entity. For example, the operation of determining that the first user is a verified user may be based on accessing a global cybercrime database (for example, which may be known as a “GDCC”), or any other type of cybercrime database, which may be administered by a group of international companies attempting to combat cybercrime. The GDCC, or other type of database, may be used to confirm that certain data associated with the first user is not flagged in the database. For example, the data may include one or more individual names, an entity name (for example, if the first user is an entity and not an individual), an IP address used to login to communicate with the vault module, server, or a host module, an email address, a domain name, a phone number, and a physical mailing or contact address. In some embodiments, the database may also be associated with information other than cybercrime information. For example, a database such as the Lexis-Nexis database may be search for a name, home address, home phone number, and state driver's license number of the first user.

The operation of determining that the user is a verified user may also be based on utilizing a third party that offers information on commercial credit as well as reports on entities (for example Dun & Bradstreet (D&B)). The third party may be used to access company records for an entity (for example, if the first user is an entity) as well as a Federal Employee Identification Number (FEIN) information.

The operation of determining that the first user is a verified user may also be based on searching one or more websites (for example, the Secretary of State website) for particular individual and entity names, for entity registration, annual filings, registered officers, and/or registered agent information. The registered agent information may also be associated with names of individuals being verified.

The operation of determining that the first user is a verified user may also be based on searching an internet search engine for the first user's name, entity name, IP address used to login or register with the vault module, any email addresses, domain names, phone numbers, and/or physical mailing addresses.

The operation of determining that the first user is a verified user may also be based on searching a map application program or website for each physical mailing address to confirm the mapped building matches disclosed description.

The operation of determining that the user is a verified user may also be based on searching a social media platform for an individual's names or entity name;

The operation of determining that the user is a verified user may also be determined based on searching and analyzing the entity's website to confirm a match with any disclosed information.

The operation of determining that the user is a verified user may also be determined based on performing WHOIS searches for each domain to determine to whom a particular domain was registered and when the domain was registered to correlate with provided registration data and any publicly available data.

The operation of determining that the first user is a verified user may also be determined based on establishing multi-factor authentication with the first user through at least two different methods chosen from among phone text, phone call, and an alternative email address.

The operation of determining that the user is a verified user may also be determined based on requiring at least two individuals from an entity be confirmed and credentialed.

In some embodiments, the process may include an operation 206 of facilitating access for payors, lendors, and investors to view results of the confirmation of the first user.

in some embodiments, the process may include an operation 208 of receiving, from a payor, firmographic information for verifying an identity of the payor. A payor can use a client device (for example, the client computing device 104 with respect to FIG. 1) to interact with a vault module via a user interface provided by or otherwise associated with the vault module. The payor may input to the vault module certain firmographic information that is used to initially verify the identity of the payor and confirm the identity in the future. A payor can use a client device to interact with a vault module via a user interface operating in association with the vault module to retrieve both a payee's physical remittance address and a bank address, including a routing number and account number, for electronic (wires and ACH) payments for payees to whom the payor is linked. The vault module can utilize a verification process (for example, the same verification process used with respect to the payee as described above) to confirm the identity of the payor, and any designated individuals authorized to register and access the remittance address and bank address of linked payees. In some instances, only payees may change a remittance address. In such instances, payors, lenders, and investors may only read the remittance address.

In some embodiments, the process may include an operation 210 of confirm the identity of the payor. Confirming the identity of the payor may involve some or all of the same confirmation methods as described with respect to confirming the identity of the first user.

In some embodiments, the process may include an operation 212 of facilitating access for payees, lendors, and investors to view results of the confirmation of the payor.

In some embodiments, the process may include an operation 214 of receiving, from a lender, firmographic information for verifying an identity of a lender.

In some embodiments, the process may include an operation 216 of confirming the identity of the lender. Confirming the identity of the lender may involve some or all of the same confirmation methods as described with respect to confirming the identity of the first user.

in some embodiments, the process may include an operation 218 of facilitating access for payees, payors, and investors to view results of the confirmation of the lender.

In some embodiments, the process may include an operation 220 of receiving, from an investor, firmographic information for verifying an identity of the investor.

In some embodiments, the process may include an operation 222 of confirm the identity of the investor. Confirming the identity of the investor may involve some or all of the same confirmation methods as described with respect to confirming the identity of the first user.

In some embodiments, the process may include an operation 206 of facilitate access for payees, payors, and lenders to view results of the confirmation of the investor.

A payor can use a client device to interact with a vault module via a user interface provided by or otherwise associated with the vault module. The payor may input to the vault module certain firmographic information that is used to initially verify the identity of the payor and confirm the identity in the future. A payor can use a client device (for example, the client computing device 104 with respect to FIG. 1) to interact with a vault module via a user interface operating in association with the vault module to retrieve both a payee's physical remittance address and a bank address, including a routing number and account number, for electronic (wires and ACH) payments for payees to whom the payor is linked. The vault module can utilize a verification process (for example, the same verification process used with respect to the payee as described above) to confirm the identity of the payor, and any designated individuals authorized to register and access the remittance address and bank address of linked payees. In some instances only payees may change a remittance address. In such instances, payors, lenders, and investors may only be able to read the remittance address.

In certain embodiments, a vault module can use a verification process for each user to confirm his, her, or its (for example, if the user is an entity) identity. The vault module can, during the verification process, determine if the user has a negative listing in one or more global databases, which may adversely impact the result of the verification process. At least some of the information initially collected from a user during the registration process can be used to verify the identity of the user. Other information initially collected during the registration can permit the user's identity to be sufficiently verified to provide the user with access to make any changes in previously stored data in the vault or stored by the vault module.

### Example Linking Processes

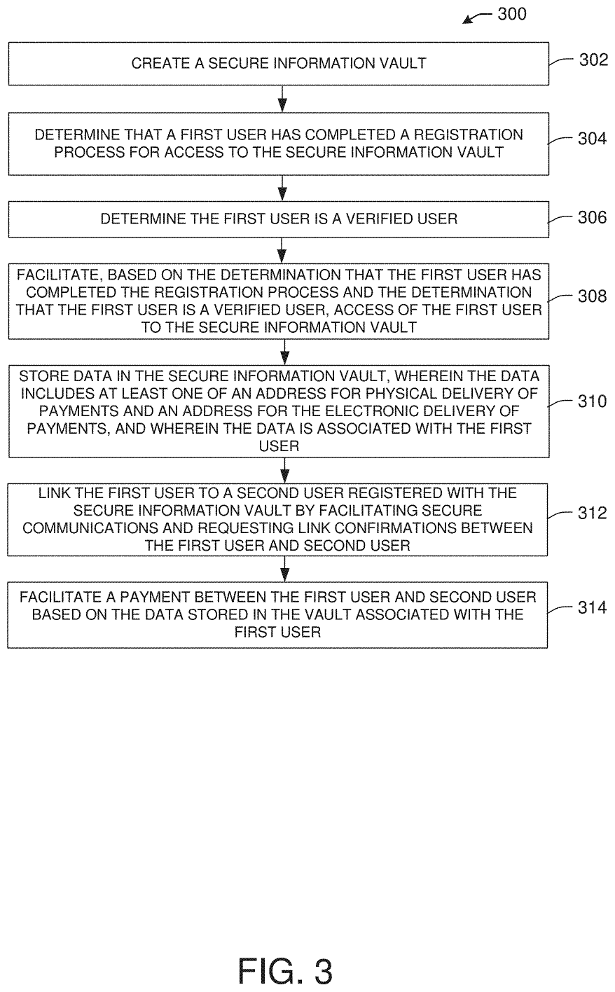

FIG. 3 illustrates a flow diagram of an example process 300 in accordance with one or more embodiments of the disclosure.

In some embodiments, the process may include an operation 302 of creating a secure information vault. The secure information vault may, in some instances, be implemented as an application program module executing on a server or other computing device accessible via a network, such as the Internet or local area network. The application program module may store data in one or more data stores, databases, and/or data files stored on the server or otherwise accessible via a network, such as the Internet or local area network. The vault can securely receive and store, for example, the addresses for physical delivery of payments (e.g., paper checks) and the electronic delivery of payments (e.g., electronic wire and ACH (Automated Clearing House)). The vault may only be accessed by persons and/or entities (collectively “users”, or individually a “user”) who have first registered to access the vault, and subsequently have been confirmed to access the vault through a verification process. This verification process may include multiple iterations and/or operations to verify the identity of the user registered to access the vault.

In some embodiments, the process may include an operation 304 of determining that a first user has completed a registration process for access to the secure information vault. The first user may be an individual or an entity. The registration process, for example, may be described in more detail with reference to FIG. 2.

In some embodiments, the process may include an operation 306 of determining the user is a verified user. The determination that the first user is a verified user may differ based on whether the first user is an individual or an entity. In some cases, however, the verification of the first user may also involve some of the same operations regardless of whether the first user is an individual or entity. For example, the operation of determining that the first user is a verified user may be based on accessing a global cybercrime database (for example, which may be known as a “GDCC”), or any other type of cybercrime database, which may be administered by a group of international companies attempting to combat cybercrime. The GDCC, or other type of database, may be used to confirm that certain data associated with the first user is not flagged in the database. For example, the data may include one or more individual names, an entity name (for example, if the first user is an entity and not an individual), an IP address used to login to communicate with the vault module, server, or a host module, an email address, a domain name, a phone number, and a physical mailing or contact address. In some embodiments, the database may also be associated with information other than cybercrime information. For example, a database such as the Lexis-Nexis database may be search for a name, home address, home phone number, and state driver's license number of the first user.

The operation of determining that the user is a verified user may also be based on utilizing a third party that offers information on commercial credit as well as reports on entities (for example Dun & Bradstreet (D&B)). The third party may be used to access company records for an entity (for example, if the first user is an entity) as well as a Federal Employee Identification Number (FEIN) information.

The operation of determining that the first user is a verified user may also be based on searching one or more websites (for example, the Secretary of State website) for particular individual and entity names, for entity registration, annual filings, registered officers, and/or registered agent information. The registered agent information may also be associated with names of individuals being verified.

The operation of determining that the first user is a verified user may also be based on searching an internet search engine for the first user's name, entity name, IP address used to login or register with the vault module, any email addresses, domain names, phone numbers, and/or physical mailing addresses.

The operation of determining that the first user is a verified user may also be based on searching a map application program or website for each physical mailing address to confirm the mapped building matches disclosed description.

The operation of determining that the user is a verified user may also be based on searching a social media platform for an individual's names or entity name;

The operation of determining that the user is a verified user may also be determined based on searching and analyzing the entity's website to confirm a match with any disclosed information.

The operation of determining that the user is a verified user may also be determined based on performing WHOIS searches for each domain to determine to whom a particular domain was registered and when the domain was registered to correlate with provided registration data and any publicly available data.

The operation of determining that the first user is a verified user may also be determined based on establishing multi-factor authentication with the first user through at least two different methods chosen from among phone text, phone call, and an alternative email address.

The operation of determining that the user is a verified user may also be determined based on requiring at least two individuals from each entity be confirmed and credentialed.

In some embodiments, the process may include an operation 308 of facilitating, based on the determination that the first user has completed the registration process and the determination that the first user is a verified user, access of the first user to the secure information vault. Once the first user has access to the secure information vault, the user may have the capability to perform any of the operations described herein with respect to the secure information vault. For example, the first user may be able to request a link with another user and/or facilitate a transaction with another user.

In some embodiments, the process may include an operation 310 of storing data in the secure information vault, wherein the data includes at least one of an address for physical delivery of payments and an address for the electronic delivery of payments, and wherein the data is associated with the first user. In some instances, any other data that may be used in performing a transaction between users may be stored in the secure information vault. The data may later be accessed and used to facilitate a transaction between two users, for example a payee and a payor.

In some embodiments, the process may include an operation 312 of linking the first user to a second user registered with the secure information vault by facilitating secure communications and requesting link confirmations between the first user and second user. Certain linking relationships between various types of users may be established and administered. For example, a payee can be linked to multiple payors, lenders, and investors, but may only be linked to only to one assignee. As another example, an assignee may be linked to multiple payees. As another example, a payor may be linked to multiple payees, lenders, and investors. As another example, a lender may be linked to multiple payors and payees. As another example, an investor can be linked to multiple payors and payee. As another example, a single user can be a payee, a payor, a lender, an investor, and an assignee. As another example, each user can be linked to multiple other users.

Individuals can be linked to multiple users.

Upon or after a verification of the first user's identity, the vault module may provide a user interface for the first user operating a client device to link to one or more other users desiring to receive or send a payment to the verified first user. In one embodiment, for example, at least one server device and/or client device executing a vault module can be operable to facilitate linking two registered and verified users together via one or more link procedures. Each of the users can be linked to another user upon mutual confirmation of a link between or sent to the users. In some instances, only verified users may be able to link together in any of the linking processes. By permitting one-to-one linking, security of the secure information vault may be increased.

In some embodiments, the users may include a payee (for example, a user to receive a payment) and a payor (for example, a user to send a payment). While a payee may have multiple payors, and vice-versa, a payee may be prevented from seeing other payees of a payor. In addition to a payor, a payee may have the capability to link to a lender or investor, and the payor, lender, and/or investor can link to the payee. In some instances, however, the payees may not be allowed to link to another payee, a payor may not be allowed to link to another payor, a lender may not be allowed to link to another lender, and an investor may not be allowed to link to another investor. That is, only a payment receiving user and a payment sending user may be linked together in these instances.

In some embodiments, a vault module can, upon a request to facilitate linking of two registered and verified users, provided one of the users is a payee, generate an invitation, such as an email, a letter for regular postal mailing, a text message, or a phone call, to contact each of the users to confirm the link by accessing the vault module. In certain instances, the invitation can include a link key, such as a unique alphanumeric code. When both of the users confirm receipt of the invitation and satisfy any instructions within the invitation, the linking process can generate and send a confirmation to both users indicating the link has been confirmed and the users are linked.

In some embodiments, a registered and confirmed user, known as a requestor, can input, via the vault module, another user (e.g., a “target”) with whom the requestor desires to be linked. Input can be received via the vault module, for example, through a user interface such as a single party entry page output to a display screen, or by uploading to the vault module contact information for one or more targets. A requestor may receive two lists of targets: (1) targets that have been tentatively matched and are registered by the vault module, and (2) targets that have not been matched. A target or registered user may receive an email invitation from the vault module to login and confirm a requested match. In some instances, the invitation to a target or registered user may not identify the requestor, but rather, may only identify that a requestor has requested a match. Emails and/or physical mail sent by the vault module to a target may contain a suitable or minimum amount of information to request the target to login to the vault module using secure credentials. In some instances, the invitation to a target or registered user may contain a numerical link key that facilitates the association of the users. A target that is neither matched nor registered may receive an invitation to register with the vault module. Once registered and confirmed, the newly registered user can be presented with one or more pending lists of match requests.

In one embodiment, to be registered, a payor may be required to agree that it has received notice of the remittance addresses to which it is linked and that the payor is bound by statutory requirements that its obligation to the payee may only be discharged by payment to the payee's remittance address in the vault module.

In any instance, the vault module can provide lists for each linked and matched user, and those users for which requests have been made, with a status of the match request.

In some embodiments, the process may include an operation 314 of facilitating a payment between the first user and second user based on the data stored in the vault associated with the first user. For example, the payment may be facilitated using the addresses for physical delivery of payments (e.g., paper checks) associated with the first user and/or the information for electronic delivery of payments (e.g., electronic wire and ACH (Automated Clearing House)) associated with the first user.

### Example Vault Module Embodiments

A vault module may operate in at least two different modes as described below, which may include a basic mode and/or a plus or enhanced mode. In some embodiments, a vault module can operate in a basic mode including some or all of the foregoing described registration, verification, and linking functionality. The basic mode may include the following conditions and/or functionality. While a payee (the seller) may notify the payor that the payor must only use the remittance address stored by the vault module, there may not be any mechanism to compel the payor to do so (that is, only to using the remittance address stored by the vault). The payor may acknowledge the payee's instructions through the vault module, wherein the acknowledgement can enhance the payee's position. However, a transaction record stored by a vault module can be utilized to demonstrate that a payee, which may not have received a payment due to remittance fraud, has exercised due care in the management of its remittance address. The transaction record stored by the vault module may be accessible by a payor and/or payee, or other user who may be identified in the transaction record, and the transaction record may include transaction data including dates, times, user information, and other information associated with a user's interaction with the vault module.

In another embodiment, a vault module can operate in a plus or enhanced mode including some or all of the foregoing described registration, verification, and linking functionality. The plus or enhanced mode may include the following conditions and/or functionality. A payee can assign any number of accounts and/or payments to another user, or users, (for example, an “assignee” or “assignees”) specified by a vault module or otherwise instructed by a user via the vault module. The vault module may generate and transmit a notification, on behalf of the assignee or assignees, to the payor to only pay the assignee or assignees, and that the obligation of the payor to the payee may only be discharged by payment to the payee's remittance address in the vault module. The plus or enhanced mode can provide certain protections to payment transactions under these conditions and/or subject to this functionality.

### Example Client and Administrator Device Hardware and Now Security Processor

FIG. 4 illustrates an example computer system architecture 400 according to an embodiment of the disclosure. The example computer system architecture 400, for example, may be associated with the client computing device 104 and 106 and administrator computing device 108 with respect to FIG. 1. In some embodiments, the system architecture 400 may include one or more processors 402 that may include any suitable processing unit capable of accepting digital data as input, processing the input data based on stored computer-executable instructions, and generating output data. The computer-executable instructions may be stored, for example, in the data storage 408 and may include, among other things, operating system software and application software. The computer-executable instructions may be retrieved from the data storage 408 and loaded into the memory 404 as needed for execution. The processor 402 may be configured to execute the computer-executable instructions to cause various operations to be performed. Each processor 402 may include any type of processing unit including, but not limited to, a central processing unit, a microprocessor, a microcontroller, a Reduced Instruction Set Computer (RISC) microprocessor, a Complex Instruction Set Computer (CISC) microprocessor, an Application Specific Integrated Circuit (ASIC), a System-on-a-Chip (SoC), a field-programmable gate array (FPGA), and so forth.

The data storage 408 may store program instructions that are loadable and executable by the processors 402, as well as data manipulated and generated by one or more of the processors 402 during execution of the program instructions. The program instructions may be loaded into the memory 126 as needed for execution. Depending on the configuration and implementation of each of the client devices 104 and 106, the memory 404 may be volatile memory (memory that is not configured to retain stored information when not supplied with power) such as random access memory (RAM) and/or non-volatile memory (memory that is configured to retain stored information even when not supplied with power) such as read-only memory (ROM), flash memory, and so forth. In various implementations, the memory 404 may include multiple different types of memory, such as various forms of static random access memory (SRAM), various forms of dynamic random access memory (DRAM), unalterable ROM, and/or writeable variants of ROM such as electrically erasable programmable read-only memory (EEPROM), flash memory, and so forth.

Various program modules, applications, or the like may be stored in data storage 408 that may comprise computer-executable instructions that when executed by one or more of the processors 402 cause various operations to be performed. The memory 404 may have loaded from the data storage 408 one or more operating systems (O/S) that may provide an interface between other application software (e.g., dedicated applications, a browser application, a web-based application, a distributed client-server application, etc.) executing on the client computing device 104 and 106 and administrator computing device 108 and the hardware resources of the client computing device 104 and 106 and administrator computing device 108. More specifically, the O/S may include a set of computer-executable instructions for managing the hardware resources of the client computing device 104 and 106 and administrator computing device 108 and for providing common services to other application programs (e.g., managing memory allocation among various application programs). The O/S may include any operating system now known or which may be developed in the future including, but not limited to, any mobile operating system, desktop or laptop operating system, mainframe operating system, or any other proprietary or open-source operating system.

In some embodiments, the example computer system architecture 400 may also include one or more input interfaces 410 and one or more output interfaces 412. The input interface 410 may serve to receive inputs from one or more users (for example, users 114, 116, and 118 with respect to FIG. 1). Such inputs may be used to perform certain actions, such as registering a user with the secure information vault, or facilitating a transaction between two users. The output interface 412 may be used to present information to the user (for example, users 114, 116, and 118). Additionally, the input interface 410 and output interface 412 may be in the form of a user interface (for example the vault application 128 with respect to FIG. 1) that allows the user to interact with the secure information vault.

In some embodiments, the example computer system architecture 400 may also include a communication bus 406, which may allow all of the different components (e.g., processor 402, memory 404, input interface 410, output interface 412, and data store 408) to communicate with one another.

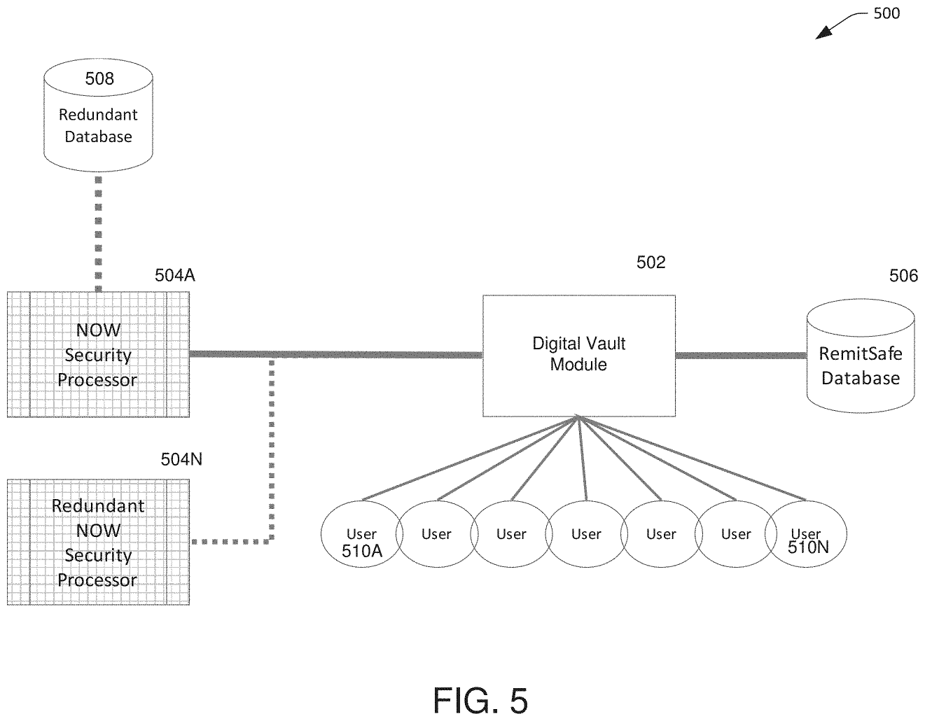

FIG. 5 illustrates an example computer processor according to an embodiment of the disclosure. In some embodiments the processor may be one or more special purpose hardware or processors, for example, such as a NOW Security Processor (“NSP”) 504A. The one or more special purpose hardware or processors can process certain digital data records that may require or otherwise need a relatively high degree of protection, such as data records (e.g., remittance address records) used as part of a digital vault module 502, for example, such as a RemitSafe Digital Vault. Each NSP can have a set of controls that can allow up to, for example, 1.8×10¹⁹ possible values of an encoding key for each NSP unit.

Each NSP can receive one or more data records from the digital vault module 502, and can further create a cryptographic hash digest, which may be known as a NOW Security Key (“NSK”), which may be unique to a particular dataset and unique to a particular hardware or processor, such as a NSP, on which it was created. The NSK can be returned to the vault application, such as the digital vault module 502, and stored in a database 506 with the original data record set.

In some embodiments, the NSK may be used in at least three different modes:

In a first example mode, periodically (e.g., hourly), datasets and the NSK can be transmitted to the NSP that created the NSK (or a NSP that is set to the same encoding key value), which creates a new NSK that is compared to the original. If the two NSKs are different, it may be determined that the record set has changed without authorization. If this is the case, the an intrusion may be identified and the record set may be marked as compromised.

In a second example mode, each time a user retrieves a set of records that are protected with the NSP (e.g., retrieving a remittance address), the record set can be transmitted to the NSP for a comparison of keys, in a manner similar to the first example mode above. As in the first example mode, if the two NSKs are different, it may be determined that the record set has changed without authorization, an intrusion may be identified and the record set may be marked as compromised.

In a third example mode, when any of the records protected with the NSP are changed (e.g., an authorized user changing the remittance address of a payee), a new NSK may be created for the old dataset to make certain that no change has occurred and a second new NSK may be created for the new dataset, which may be stored in the digital vault database 506.

In addition to these three modes, a second or more NSP may be used in a network architecture and/or environment, each NSP providing a uniquely created NSK.

A NSP can provide a significantly higher level of security than a software only process. For example, a cybercriminal would have to gain physical possession of the NSP hardware to duplicate the encoding. The NSP hardware can be operated in the same local network as a vault module, such as the digital vault module 502, or it may be in a physically separate location connected via a network, such as the Internet or a private network. Locating the NSP in a physically separate location can reduce the likelihood a vault module protected remittance address, such as a digital vault protected remittance address, can be compromised. Locating two or more NSPs in separate locations provides an even greater level of security.

In any instance, the digital vault module 502, can be programmed on a predefined number of NSPs, each of which must confirm the record set being examined for a “pass” or “fail”, depending on the level of security required or otherwise needed for the particular data set.

In certain embodiments, the NSP hardware can also be used to pass a redundant copy of database 506, such as redundant database 508, for safekeeping and additional security.

The architecture, system, and methodology described above are provided by way of example only. Numerous other operating environments, system architectures, device configurations, process and method flows are possible. Other architecture and system embodiments can include fewer or greater numbers of components and may incorporate some or all of the functionality described with respect to the architecture or system components shown. Accordingly, embodiments of the disclosure should not be construed as being limited to any particular operating environment, system architecture, or device configuration.

The disclosure described above can be with reference to block and flow diagrams of systems, methods, apparatuses, and/or computer program products according to example embodiments of the disclosure. It will be understood that one or more blocks of the block diagrams and flow diagrams, and combinations of blocks in the block diagrams and the flow diagrams, respectively, can be implemented by computer-readable program instructions. Likewise, some blocks of the block diagrams and flow diagrams may not necessarily need to be performed in the order presented, or may not necessarily need to be performed at all, according to some embodiments of the disclosure.

Various block and/or flow diagrams of systems, methods, apparatus, and/or computer program products can be described with respect to the above example embodiments of the disclosure. It will be understood that one or more blocks of the block diagrams and flow diagrams, and combinations of blocks in the block diagrams and flow diagrams, respectively, can be implemented by computer-readable program instructions. Likewise, some blocks of the block diagrams and flow diagrams may not necessarily need to be performed in the order presented, or may not necessarily need to be performed at all, according to some embodiments of the disclosure.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or operations to be performed on the computer or other programmable apparatus to produce a computer-implemented process such that the instructions that execute on the computer or other programmable apparatus provide elements or operations for implementing the functions specified in the flow diagram block or blocks.

Accordingly, blocks of the block diagrams and flow diagrams support combinations of means for performing the specified functions, combinations of elements or operations for performing the specified functions and program instruction means for performing the specified functions. It will also be understood that each block of the block diagrams and flow diagrams, and combinations of blocks in the block diagrams and flow diagrams, can be implemented by special purpose, hardware-based computer systems that perform the specified functions, elements or steps, or combinations of special purpose hardware and computer instructions.

Many modifications and other embodiments of the disclosure set forth herein will be apparent having the benefit of the teachings presented in the foregoing descriptions and any associated drawings. Therefore, it is to be understood that the disclosure is not to be limited to the specific embodiments disclosed and that modifications and other embodiments are intended to be included within the scope of the appended proposed claims. Although specific terms are employed herein, they are used in a generic and descriptive sense only and not for purposes of limitation.

1. A secure payment system comprising:
a computer processor operable to execute a set of computer-readable instructions; and
a memory operable to store the set of computer-readable instructions operable to:
create a secure information vault;
determine that a first user has completed a registration process for access to the secure information vault;
determine that the first user is a verified user;
facilitate, based on the determination that the first user has completed the registration process and the determination that the first user is a verified user, access of the first user to the secure information vault;
store data in the secure information vault, wherein the data includes at least one of an address for physical delivery of payments and an address for electronic delivery of payments, and wherein the data is associated with the first user;
link the first user to users a second user by facilitating secure communications and requesting link confirmations between the first user and second user; and
facilitate a payment between the first user and second users based on the data stored in the vault associated with the first user.

2. The system of claim 1, wherein the first user is a payee and the second user is a payor.

3. The system of claim 1, wherein the first user comprises at least one of an individual or an entity.

4. The system of claim 1, wherein determining that the first user is a verified user further comprises at least one of: searching for the first user in a global cybercrime database; searching company records for entity and Federal Employee Identification Numbers (FEIN) associated with the first user; searching a database using a name, home address, home phone number, or state driver's license number of the first user, searching for entity registration, annual filings, registered officers, and a registered agent associated with the first user; performing an internet search engine search for an individual name, entity name, or IP address used to login or register with the secure information vault, any email addresses, domain names, phone numbers, or physical mailing addresses provided during the registration process; searching a map application program or website for the physical mailing address to confirm a mapped building matches a disclosed description; searching a professional social media web site for an individual names or entity name associated with the first user; searching a website of the first user to confirm a match with any disclosed information; using multi-factor authentication with the first user through at least two different methods from among phone text, phone call, and alternative email; and requiring at least two users from an entity be confirmed and credentialed.

5. The system of claim 1, wherein link the first user to a second user further comprises:
receive, from the first user, a request to establish a link with a second user; and
determine that the second user is registered with the secure information vault.

6. The system of claim 1, wherein link the first user to a second user further comprises:
receive, from the first user, a request to establish a link with a second user;
determine that the second user is not registered with the secure information vault;
send an invitation to the second user to register with the secure information vault; and
determine, subsequent to sending the invitation, that the second user has registered with the secure information vault.

7. The system of claim 1, wherein the set of computer-readable instructions are further operable to:
receive, from the first user, an indication of one or more payments to be assigned to at a third user, wherein the third user is an assignee;
generate a notification, on behalf of the third user, that the second user is to only pay the third user; and
facilitate payment to the first user based on the data stored in the secure information vault, wherein the payment discharges a payment obligation of the second user.

8. The system of claim 1, wherein the set of computer-readable instructions are further operable to:
create a first cryptographic hash key that is unique to the processor and the data;
create, periodically, a second cryptographic hash key unique to the processor and the data;
compare the first cryptographic hash key and the second cryptographic hash key;
determine, based on the comparison of the first cryptographic hash key and the second cryptographic hash key, that the first cryptographic hash key and the second cryptographic hash key are different; and
determine, based on the determination that the first cryptographic hash key and the second cryptographic hash key are different, that the data was altered without authorization.

9. The system of claim 1, wherein the set of computer-readable instructions are further operable to:
create a first cryptographic hash key that is unique to the processor and the data;
determine that the data has been accessed by the first user or the second user;
create, based on the determination that the data has been accessed by the first user or the second user, a second cryptographic hash key unique to the processor and the data;
compare the first cryptographic hash key and the second cryptographic hash key;
determine, based on the comparison of the first cryptographic hash key and the second cryptographic hash key, that the first cryptographic hash key and the second cryptographic hash key are different; and
determine, based on the determination that the first cryptographic hash key and the second cryptographic hash key are different, that the data was altered without authorization.

10. The system of claim 1, wherein the set of computer-readable instructions are further operable to:
create a first cryptographic hash key that is unique to the processor and the data;
determine that the data has been modified by an authorized user; and
create a second cryptographic hash key unique to the processor and the modified data.

11. A secure payment method comprising:
creating, by a payment system, a secure information vault;
determining, by the payment system, that a first user has completed a registration process for access to the secure information vault;
determining, by the payment system, that the first user is a verified user;
facilitating, by the payment system, and based on the determination that the first user has completed the registration process and the determination that the first user is a verified user, access of the first user to the secure information vault;
storing, by the payment system, data in the secure information vault, wherein the data includes at least one of an address for physical delivery of payments and an address for electronic delivery of payments, and wherein the data is associated with the first user;
linking, by the payment system, the first user to a second user registered with the secure information vault by facilitating secure communications and requesting link confirmations between the first user and second user; and
facilitating, by the payment system, a payment between the first user and second user based on the data stored in the vault associated with the user.

12. The method of claim 11, wherein the first user is a payee and the second user is a payor.

13. The method of claim 11, wherein the first user comprises at least one of an individual or an entity.

14. The method of claim 11, wherein determining that the first user is a verified user further comprises at least one of: searching for the first user in a global cybercrime database; searching company records for entity and Federal Employee Identification Numbers (FEIN) associated with the first user; searching a database using a name, home address, home phone number, or state driver's license number of the first user, searching for entity registration, annual filings, registered officers, and a registered agent associated with the first user; performing an internet search engine search for an individual name, entity name, or IP address used to login or register with the secure information vault, any email addresses, domain names, phone numbers, or physical mailing addresses provided during the registration process; searching a map application program or website for the physical mailing address to confirm a mapped building matches a disclosed description; searching a professional social media web site for an individual names or entity name associated with the first user; searching a website of the first user to confirm a match with any disclosed information; using multi-factor authentication with the first user through at least two different methods from among phone text, phone call, and alternative email; and requiring at least two users from an entity be confirmed and credentialed.

15. The method of claim 11, wherein link the first user to a second user further comprises:
receiving, from the first user, a request to establish a link with a second user; and
determining that the second user is registered with the secure information vault.

16. The method of claim 11, wherein link the first user to a second user further comprises:
receiving, from the first user, a request to establish a link with a second user;
determining that the second user is not registered with the secure information vault;
sending an invitation to the second user to register with the secure information vault; and
determining, subsequent to sending the invitation, that the second user has registered with the secure information vault.

17. The method of claim 11, further comprising:
receiving, from the first user, an indication of one or more payments to be assigned to at a third user, wherein the third user is an assignee;
generating a notification, on behalf of the third user, that the second user is to pay the third user; and
facilitating payment to the first user based on the data stored in the secure information vault, wherein the payment discharges a payment obligation of the second user.

18. The method of claim 11, further comprising:
creating a first cryptographic hash key that is unique to a processor and the data;
creating, periodically, a second cryptographic hash key unique to the processor and the data;
comparing the first cryptographic hash key and the second cryptographic hash key;
determining, based on the comparison of the first cryptographic hash key and the second cryptographic hash key, that the first cryptographic hash key and the second cryptographic hash key are different; and
determining, based on the determination that the first cryptographic hash key and the second cryptographic hash key are different, that the data was altered without authorization.

19. The method of claim 11, further comprising:
creating a first cryptographic hash key that is unique to the processor and the data;
determining that the data has been accessed by the first user or the second user;
creating, based on the determination that the data has been accessed by the first user or the second user, a second cryptographic hash key unique to a processor and the data;
comparing the first cryptographic hash key and the second cryptographic hash key;
determining, based on the comparison of the first cryptographic hash key and the second cryptographic hash key, that the first cryptographic hash key and the second cryptographic hash key are different; and
determining, based on the determination that the first cryptographic hash key and the second cryptographic hash key are different, that the data was altered without authorization.

20. The method of claim 11, further comprising:
creating a first cryptographic hash key that is unique to a processor and the data;
determining that the data has been modified by an authorized user; and
creating a second cryptographic hash key unique to the processor and the modified data.
